(19) United States
(12) Patent Application Publication
(10) Pub. No.: US 2016/0273920 A1
(43) Pub. Date: Sep. 22, 2016

(54) DIRECTION ESTIMATING DEVICE, DIRECTION ESTIMATING SYSTEM, AND METHOD OF ESTIMATING DIRECTION

(71) Applicants: Yusuke MATSUSHITA, Kanagawa (JP); Takeo TSUKAMOTO, Kanagawa (JP); Daisuke HATA, Saitama (JP); Hiroto HIGUCHI, Kanagawa (JP); Yukio FUJIWARA, Kanagawa (JP); Fumio YOSHIZAWA, Kanagawa (JP); Takanori INADOME, Kanagawa (JP); Ryohsuke KAMIMURA, Kanagawa (JP); Hideaki ARATANI, Kanagawa (JP); Kenji KAMEYAMA, Kanagawa (JP); Katsuya YAMAMOTO, Kanagawa (JP); Keisuke KONISHI, Kanagawa (JP); Juuta KON, Tokyo (JP); Tomoyo NARITA, Tokyo (JP)

(72) Inventors: Yusuke MATSUSHITA, Kanagawa (JP); Takeo TSUKAMOTO, Kanagawa (JP); Daisuke HATA, Saitama (JP); Hiroto HIGUCHI, Kanagawa (JP); Yukio FUJIWARA, Kanagawa (JP); Fumio YOSHIZAWA, Kanagawa (JP); Takanori INADOME, Kanagawa (JP); Ryohsuke KAMIMURA, Kanagawa (JP); Hideaki ARATANI, Kanagawa (JP); Kenji KAMEYAMA, Kanagawa (JP); Katsuya YAMAMOTO, Kanagawa (JP); Keisuke KONISHI, Kanagawa (JP); Juuta KON, Tokyo (JP); Tomoyo NARITA, Tokyo (JP)

(21) Appl. No.: 15/032,224

(22) PCT Filed: Oct. 27, 2014
(86) PCT No.: PCT/JP2014/079010

§ 371 Date: Apr. 26, 2016

(30) Foreign Application Priority Data
Oct. 28, 2013 (JP) 2013-223720
Jul. 22, 2014 (JP) 2014-149050

(51) Int. Cl. G01C 21/16

(52) U.S. Cl. CPC G01C 21/16

(57) ABSTRACT

A direction estimating device estimates a user direction indicating a direction of a body of a user. The direction estimating device includes: a storage unit that stores direction information indicating a direction determined in advance as the user direction of when the user operates an input device with a particular attitude; a detecting unit that detects that the user is in the particular attitude; and an estimating unit that estimates the user direction based on the direction information when the user has been detected to be in the particular attitude.

### TECHNICAL FIELD

The present invention relates to a direction estimating device, a direction estimating system, and a method of estimating a direction.

### BACKGROUND ART

Conventionally, an inertial navigation technology (pedestrian dead reckoning (PDR)) for pedestrian is known, in which a pedestrian wears an inertial device in which a triaxial acceleration sensor, a triaxial geomagnetic field sensor, and/or the like, are integrated, and a position and a direction of the pedestrian are detected by calculation of the inertial device (for example, see Patent Documents 1 to 4).

The technique described in Patent Document 1 is an inertial navigation technique for pedestrian in which a triaxial acceleration sensor and a triaxial geomagnetic field sensor are combined in a composite manner, and which determines a direction of travel (direction) of the pedestrian based on direction information based on a geomagnetic field. Therefore, in an indoor environment, there is a problem that direction detection accuracy is deteriorated by being subject to influence of disturbance due to turbulence of the environmental magnetic field (especially, the influence is noticeable inside a building having a ferro-concrete structure).

Meanwhile, inertial navigation techniques for pedestrian described in Patent Documents 2 to 4 use a triaxial gyro (angular velocity) sensor, in addition to the triaxial acceleration sensor and the triaxial geomagnetic field sensor. Then, for example, turbulence of the environmental magnetic field based on the geomagnetic field that serves as a reference value is detected, and when it has been determined the detected geomagnetic field is not reliable, switching to direction detection only with the gyro sensor that detects the angular velocity is performed. Therefore, deterioration of the direction detection accuracy caused by the influence of disturbance due to turbulence of the environmental magnetic field can be suppressed.

However, in the direction detection only with the gyro sensor, estimation errors are accumulated in attitude angle estimation information (the quaternion and Euler angle) due to change of zero point offset (gyro drift) that is a unique problem to gyro sensors, noises, and accumulation of integration errors. When the geomagnetic field is not reliable, the estimation errors around roll/pitch angles are resolved by observation of the acceleration sensor. However, an error around a yaw angle (direction) cannot be resolved because sensor information that is a target to be measured cannot be obtained. Therefore, there is a problem that the error of the direction cannot be corrected and the direction detection accuracy is deteriorated with time until the geomagnetic field having high reliability is detected.

In view of the foregoing, there is a need to provide a direction estimating device, a direction estimating system, and a method of estimating a direction capable of improving direction detection accuracy in an indoor environment.

### SUMMARY OF THE INVENTION

A direction estimating device estimates a user direction indicating a direction of a body of a user. The direction estimating device includes: a storage unit that stores direction information indicating a direction determined in advance as the user direction of when the user operates an input device with a particular attitude; a detecting unit that detects that the user is in the particular attitude; and an estimating unit that estimates the user direction based on the direction information when the user has been detected to be in the particular attitude.

### BRIEF DESCRIPTION OF DRAWINGS

FIG. 1 is a configuration diagram illustrating a schematic configuration of a direction estimating system.

FIG. 2 is a block diagram illustrating a functional configuration example of a direction estimating device of a first embodiment.

FIG. 3 is a diagram illustrating an example of user information stored in a storage unit of the direction estimating device.

FIG. 4 is a diagram illustrating an example of device information stored in the storage unit of the direction estimating device.

FIG. 5 is a diagram illustrating an example of direction/position information stored in the storage unit of the direction estimating device.

FIGS. 6A and 6B are diagrams describing a method of determining an attitude of a user from an operation state of a keyboard.

FIG. 7 is a block diagram illustrating a functional configuration example of a communication terminal.

FIG. 8 is a sequence diagram illustrating an operation of a direction estimating system of the first embodiment.

FIG. 9 is a schematic diagram illustrating a state in which a user direction detected by the communication terminal is corrected.

FIG. 10 is a sequence diagram illustrating an operation of a direction estimating system of when the direction estimating device is realized as one function of a device.

FIG. 11 is a block diagram illustrating a functional configuration example of a direction estimating device of a second embodiment.

FIG. 12 is a sequence diagram illustrating an operation of a direction estimating system of the second embodiment.

FIG. 13 is a schematic diagram illustrating a state in which user direction detected by a communication terminal is corrected.

FIG. 14 is a block diagram illustrating a hardware configuration example of the direction estimating device.

### DESCRIPTION OF EMBODIMENTS

Embodiments of the present invention will be herein described with reference to the appended drawings. A direction estimating device of an embodiment estimates a user direction that indicates a direction of a body of a user (which direction the body of the user faces). The user direction may be an absolute direction that can be expressed by north, south, east and west, or may be a relative direction (an angle, or the like) with respect to a reference direction determined in advance. Further, the direction estimating device of the embodiment can estimate a user position, together with the user direction. The user position may be an absolute position that can be expressed by geographic coordinates, or may be a relative position (meter, or the like) with respect to a reference position determined in advance.

The direction estimating device of the embodiment stores direction information that indicates a direction determined in advance as the user direction of when the user operates a predetermined input device with a particular attitude. Further, the direction estimating device of the embodiment stores position information that indicates a position determined in advance as the user position of when the user operates the predetermined input device with the particular attitude. Then, the direction estimating device of the embodiment estimates the user direction based on the stored direction information, and estimates the user position based on the stored position information, when having detected that the user is operating the predetermined input device with the particular attitude.

An example of the predetermined input device includes a keyboard of a personal computer used by the user, for example. The keyboard is an input device operated by the user with both hands, in which the user direction and the user position are fixed to some extent in a scene where the user naturally operates the keyboard with both hands and performs an input (in a state where a load to the user is low and the operability is high). The user direction and position of when the user operates the predetermined input unit with the particular attitude, such as operating the keyboard with both hands, can be obtained for each input device with a verification experiment in advance, and can be stored in a database. Therefore, for example, when having determined that the user is operating the predetermined input device with the particular attitude, the direction estimating device can estimate the user direction and position of that time, by reference to the database created in advance.

The user direction and position estimated by the direction estimating device of the embodiment can be transmitted to a communication terminal that independently detects the user position and position, and can be used for correcting the user direction and position detected by the communication terminal independently. An example of the communication terminal include, for example, a positioning terminal (a small indoor positioning device in which acceleration/gyro/geomagnetic field sensors and a user direction/position detection function by an inertial navigation technology (PDR) for pedestrian are incorporated) possessed (carried) by the user. The positioning terminal has a problem that especially direction estimation errors are accumulated and the direction detection accuracy is deteriorated when the positioning terminal is used in an indoor environment for a long time. Therefore, the user direction independently detected by the positioning terminal is corrected based on a user direction estimated by the direction estimating device of the embodiment. Accordingly, the direction detection accuracy can be improved.

A communication terminal (possessed by the user) that is a destination to which the user direction and position estimated by the direction estimating device of the embodiment are transmitted can be identified by identifying of the user who is operating the predetermined input device. For example, when the predetermined input device is a keyboard of a personal computer, the user who is operating the keyboard can be identified from log-in information, which is input when the user performs a log-in operation. Then, the communication terminal associated with the user can be identified as the destination to which the user direction and position estimated by the direction estimating device of the embodiment are transmitted. A corresponding relationship between the user and the communication terminal may just be created and stored as information in advance.

The direction estimating device of the embodiment can be realized as a device that includes the predetermined input device, or a server device communicatively connected to the communication terminal possessed by the user. Further, the direction estimating device of the embodiment can be realized as one function of a device (for example, a personal computer) that includes the predetermined input device. Hereinafter, an example in which the direction estimating device of the embodiment is realized as a server device will be described.

### First Embodiment

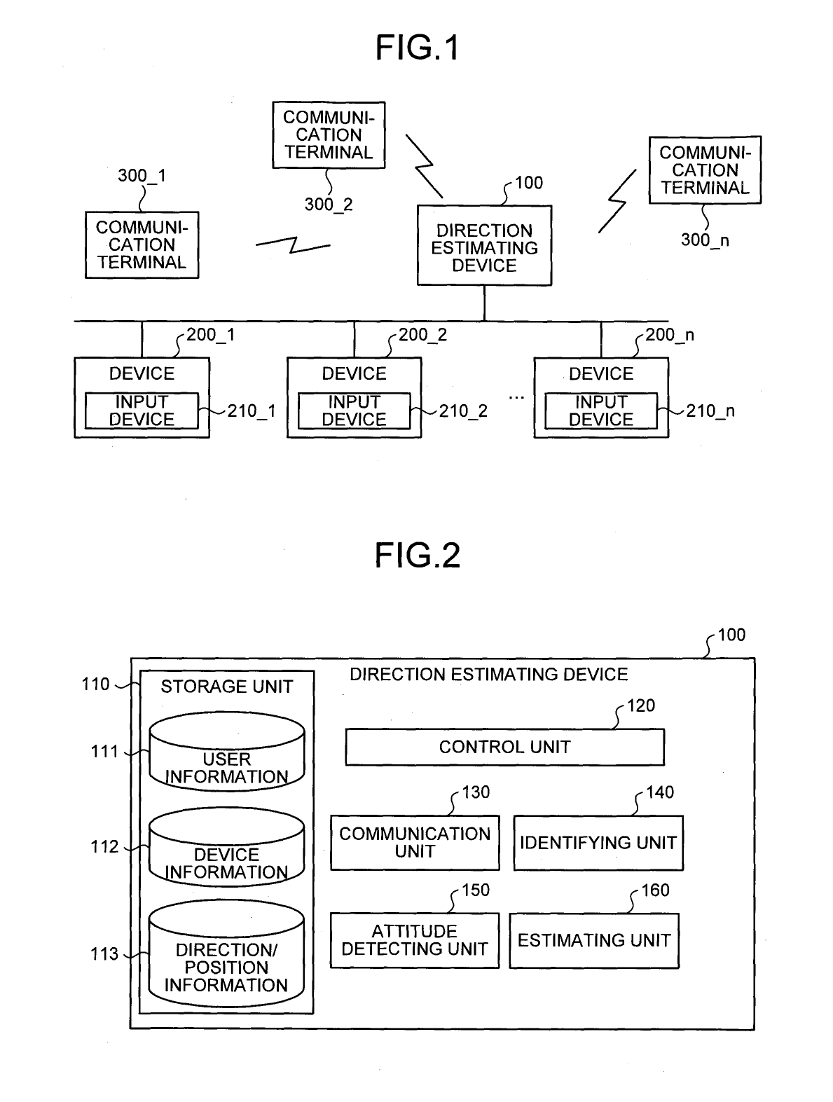

FIG. 1 is a configuration diagram illustrating a schematic configuration of a direction estimating system including a direction estimating device 100 of a first embodiment. The direction estimating system includes, as illustrated in FIG. 1, the direction estimating device 100 configured as a server device on a network, a plurality of devices 200_1, 200_2, . . . , 200_n (n is an arbitrary natural number) communicatively connected to the direction estimating device 100 through a network cable, for example, and a plurality of communication terminals 300_1, 300_2, . . . , 300_n communicatively connected to the direction estimating device 100 through a wireless LAN, for example. Note that connection between the plurality of devices 200_1, 200_2, . . . , 200_n and the direction estimating device 100 is not limited to the wired connection through the network cable, and may be, for example, connection by wireless communication using a wireless LAN, or the like.

The plurality of devices 200_1, 200_2, . . . , 200_n includes input devices 210_1, 210_2, . . . , 210_n operated by the user, respectively. Hereinafter, the plurality of devices 200_1, 200_2, . . . , 200_n are collectively described as devices 200, and the input devices 210_1, 210_2, . . . , 210_n of the respective devices 200 are collectively described as input devices 210. The input device 210 is operated by the user with a particular attitude, and is connected to a main body of the device 200 in a wired or wireless manner. Note that there is a case where a plurality of input devices 210 is connected to one device 200.

An example of the device 200 includes, for example, a personal computer. An example of the input device 210 includes, for example, a keyboard connected to a main body of the personal computer. Note that the device 200 and the input device 210 are not limited to the personal computer and the keyboard. Anything can be used as the device 200 and the input device 210, with which the user is assumed to take a particular attitude when naturally operating the input device 210 (in a state where a load to the user is low and the operability is high).

The plurality of communication terminals 300_1, 300_2, . . . , 300_n are terminals possessed by the respective users, and are positioning terminals that independently detect the user direction and position. Hereinafter, the plurality of communication terminals 300_1, 300_2, . . . , 300_n is collectively described as communication terminals 300. Note that details of a specific configuration example of the communication terminal 300 will be described later.

The direction estimating device 100 estimates the user direction and position of the user who is operating the input device 210 of the device 200, in cooperation with the device 200.

FIG. 2 is a block diagram illustrating a functional configuration example of the direction estimating device 100 of the first embodiment. The direction estimating device 100 includes, as illustrated in FIG. 2, a storage unit 110, a control unit 120, a communication unit 130, an identifying unit 140, an attitude detecting unit 150, and an estimating unit 160.

The storage unit 110 stores various types of information referred in processing in the identifying unit 140 or the estimating unit 160, described later. Examples of the information stored in the storage unit 110 include user information 111, device information 112, and direction/position information 113.

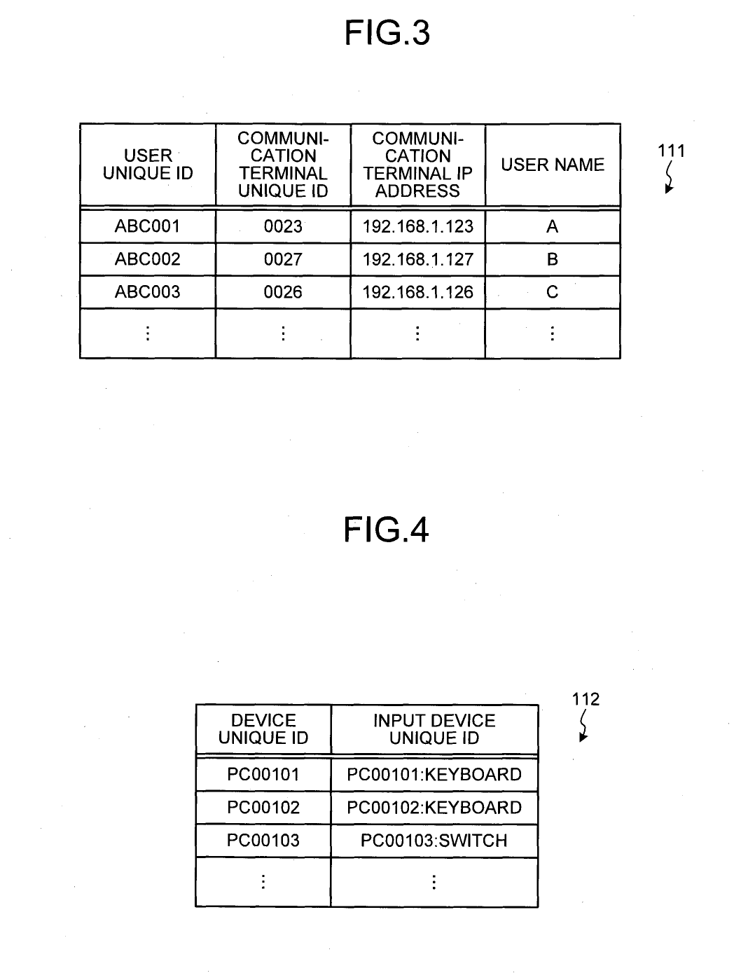

The user information 111 is a database that stores information related to the user registered as a user who uses the direction estimating system. An example of the user information 111 is illustrated in FIG. 3. The user information 111 stores, as illustrated in FIG. 3, a user unique ID uniquely allocated to each user, a communication terminal unique ID uniquely allocated to the communication terminal 300 possessed by the user, an IP address of the communication terminal 300, and a user name, in association with each other, for example.

The device information 112 is a database that stores information related to the devices 200 included in the direction estimating system. An example of the device information 112 is illustrated in FIG. 4. As illustrated in FIG. 4, the device information 112 stores, for example, a device unique ID uniquely allocated to each device 200, and an input device unique ID uniquely allocated to the input device 210 included in each device 200, in association with each other. Note that, when one device 200 includes a plurality of input devices 210, a plurality of input device unique IDs is associated with the one device unique ID.

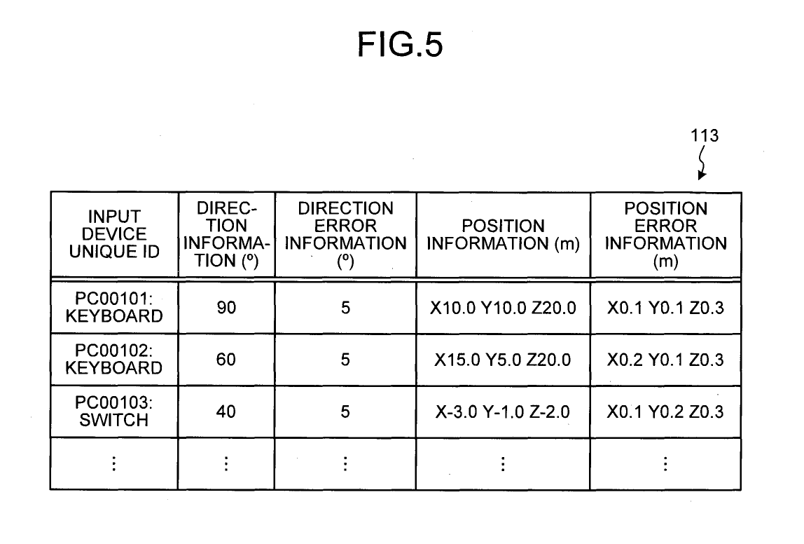

The direction/position information 113 is a database that stores information related to the user direction and position of when the user operates the input device 210 with the particular attitude. An example of the direction/position information 113 is illustrated in FIG. 5. The direction/position information 113 stores, as illustrated in FIG. 5, the input device unique ID of each input device 210, direction information that indicates a direction determined in advance as the user direction of when the user operates the input device 210 with the particular attitude and direction error information that indicates an error range of the direction information, and position information that indicates a position determined in advance as the position of when the user operates the input device 210 with the particular attitude and position error information that indicates an error range of the position information, in association with each other, for example. The direction/position information 113 is created by performing of a verification experiment in advance, and is stored in the storage unit 110, as described above.

Note that, in the example illustrated in FIG. 5, the direction information and the position information are information that does not include the direction and position of the input device 210 itself. That is, the user direction and position of when the user operates the input device 210 with the particular attitude are obtained by a verification experiment or the like in advance, and are stored as the direction information and the position information. However, the direction information and the position information may be created and stored as a combination of information indicating the direction and position of the input device 210 itself, which is not depending on the attribute of the user, and information indicating a relative direction and position with respect to the input device 210 of when the user operates the input device 210 with the particular attitude, for example.

The control unit 120 comprehensively controls an operation of the direction estimating device 100. To be specific, the control unit 120 performs control of taking out necessary information from the storage unit 110, passing the information to the identifying unit 140 and the estimating unit 160 or passing the user direction and position estimated by the estimating unit 160 to the communication unit 130, and causing the communication terminal 300 to transmit the information. In addition, the control unit 120 executes various types of control processing so that the direction estimating device 100 can function as a whole.

The communication unit 130 performs communication with the device 200 and the communication terminal 300, and exchanges various types of information, under control of the control unit 120. To be specific, the communication unit 130 receives the user unique ID from the device 200 when the user performs log-in processing to the device 200, or receives the operation information and the device unique ID from the device 200, and the input device unique ID when the user operates the input device 210. Further, the communication unit 130 transmits the user direction and position estimated by the estimating unit 160 to the communication terminal 300 possessed by the user. In addition, the communication unit 130 exchanges the various types of information with the device 200 or the communication terminal 300, as needed.

The identifying unit 140 identifies the user who is operating the input device 210 of the device 200. To be specific, the identifying unit 140 receives, from the device 200, the log-in information input by the user, thereby to identify the user who is operating the input device 210 of the device 200 when the device 200 is a personal computer. In the present embodiment, the log-in information input by the user at the time of the log-in processing includes the user unique ID. Further, when the device 200 is one that reads card information of the user and performs processing, such as an automated teller machine (ATM) or an automatic ticket gate device, the identifying unit 140 can identify the user by receiving the card information from the device 200.

The attitude detecting unit 150 determines the attribute of the user who is operating the input device 210, and detects that the user is in a particular attitude. To be specific, when the input device 210 is one that is operated with both hands, such as a keyboard, the attitude detecting unit 150 determines whether the input device 210 is being operated with both hands, and when having determined that the input device 210 is being operated with both hands, the attitude detecting unit 150 determines that the user is in the particular attitude.

Here, a specific example of a method of determining an attitude of the user with the attitude detecting unit 150 will be described in an example where the input device 210 is a keyboard. Whether the user is operating the keyboard with both hands can be determined from an operation state of the keyboard. The operation state of the keyboard is a state that indicates a position of a typed key and/or a type time interval, and is detected as an event. The operation state of the keyboard is transmitted from the device 200 to the direction estimating device 100, as operation information.

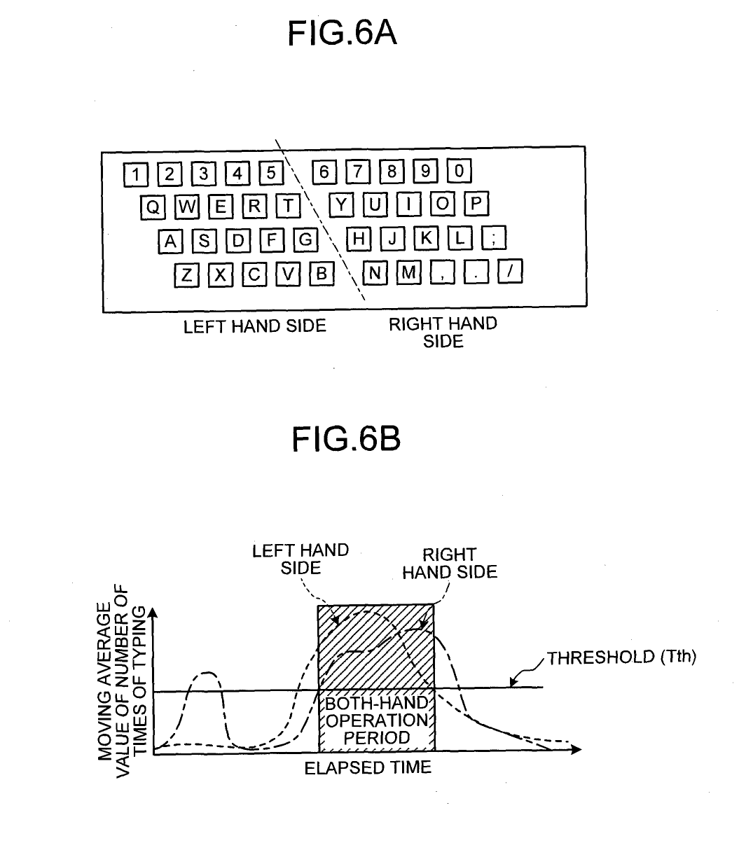

FIGS. 6A and 6B are diagrams describing a method of determining the attitude of the user from the operation state of the keyboard. FIG. 6A illustrates typically known correspondence between right and left hands and key positions, and FIG. 6B illustrates a specific example of a method of detecting that the user is operating the keyboard with both hands from a moving average value of the number of times of typing with the right and left hands.

The attitude detecting unit 150 calculates the moving average value per a predetermined time (for example, five seconds) of the number of times of typing keys (the number of times of typing) at the left hand side of the keyboard illustrated in FIG. 6A, and the moving average value per a predetermined time (for example, five seconds) of the number of times of typing keys (the number of times of typing) at the right hand side, based on the operation information transmitted from the device 200. Then, when the moving average values of the number of times of typing at both of the right hand side and the left hand side indicate a value equal to or more than a threshold (Tth), the attitude detecting unit 150 determines a state where the user is operating the keyboard with both hands, that is, a state where the user is operating the input device 210 with a particular attitude. Note that the threshold (Tth) may just be set to an optimum value in advance.

Note that, the attitude detecting unit 150 may just have a configuration capable of detecting that the user is in a particular attitude, and the detecting method is not limited to the example. For example, the attitude detecting unit 150 may have a configuration that, when the device 200 is equipped with a camera capable of capturing an image of the user, the attitude detecting unit 150 acquires an image captured by the camera, from the device 200, and analyses the image, thereby to detect that the user is in the particular attitude.

The estimating unit 160 estimates a current user direction and position based on the direction/position information stored in the storage unit 110, when the attitude detecting unit 150 has detected that the user is in the particular attitude. To be specific, when the attitude detecting unit 150 has detected that the user is in the particular attitude while the user is operating the input device 210, the estimating unit 160 estimates the user direction indicated by the direction information associated with the input device unique ID of the input device 210, as the current user direction of the user who is operating the input device 210. Further, the estimating unit 160 estimates the position indicated by the position information associated with the input device unique ID of the input device 210, as the current position of the user who is operating the input device 210.

The user direction and position estimated by the estimating unit 160 are transmitted together with the direction error information and the position error information that indicate error ranges of the user direction and position, by the communication unit 130 to the communication terminal 300 possessed by the user who is operating the input device 210.

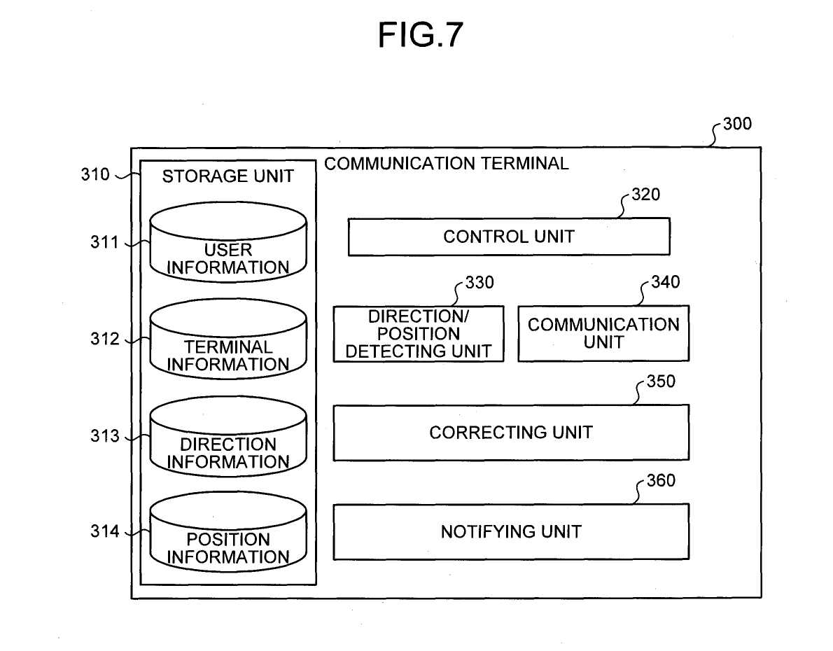

FIG. 7 is a block diagram illustrating a functional configuration example of the communication terminal 300. As illustrated in FIG. 7, the communication terminal 300 includes a storage unit 310, a control unit 320, a direction/position detecting unit 330, a communication unit 340, a correcting unit 350, and a notifying unit 360.

The storage unit 310 stores various types of information such as user information 311, terminal information 312, direction information 313, and position information 314.

The user information 311 is information related to the user who possesses the communication terminal 300, for example, and includes the user unique ID. The terminal information 312 is information related to the communication terminal 300, and includes the communication terminal unique ID and the IP address.

The direction information 313 is time-series data that indicates the user direction detected by the direction/position detecting unit 330 described later and an error thereof. The position information 314 is time-series data that indicates the user position detected by the direction/position detecting unit 330 described later and an error thereof.

The control unit 320 comprehensively controls an operation of the communication terminal 300. To be specific, the control unit 320 issues a detection command of the user direction and position to the direction/position detecting unit 330, and executes processing of storing the user direction and position detected by the direction/position detecting unit 330 in the storage unit 310. Further, the control unit 320 passes the user direction and position received by the communication unit 340 from the direction estimating device 100, the error information thereof (the user direction and position estimated by the direction estimating device 100, and the error information thereof) to the correcting unit 350, issues a correction command, and executes processing of storing, in the storage unit 310, the user direction and position corrected by the correcting unit 350. In addition, the control unit 320 executes various types of control processing so that the communication terminal 300 functions as a whole.

The direction/position detecting unit 330 detects the user direction and position by the inertial navigation technology (PDR) for pedestrian, using sensor detection values of the triaxial acceleration sensor, the triaxial gyro sensor, and the triaxial geomagnetic field sensor, for example. Further, the direction/position detecting unit 330 may include a function to correct the user direction and position detected by the PDR, using another positioning technology. Examples of another positioning technology include, for example, positioning by a global positioning system (GPS), positioning by an indoor messaging system (IMES), positioning by a Bluetooth (registered trademark), positioning with an optical beacon, positioning with a camera, positioning with a sound wave.

When the user direction and position, and the error information thereof are transmitted from the direction estimating device 100, the communication unit 340 receives these pieces of information and notifies the information to the control unit 320. In addition, the communication unit 340 performs communication with the direction estimating device 100 and other external devices, as needed, under control of the control unit 320, and exchanges various types of information.

The correcting unit 350 executes processing of correcting the current user direction and position independently detected by the direction/position detecting unit 330 based on the user direction and position estimated by the direction estimating device 100 and the error information thereof.

When reliability of the user direction and position estimated by the direction estimating device 100 is high, the correcting unit 350 can correct the user direction and position by replacing the current user direction and position detected by the direction/position detecting unit 330 with the user direction and position estimated by the direction estimating device 100, for example. Further, the correcting unit 350 can take a weighted average of the user direction and position detected by the direction/position detecting unit 330, and the user direction and position estimated by the direction estimating device 100, and can employ the obtained user direction and position as the corrected user direction and position.

Further, the correcting unit 350 may be able to employ, as the corrected user direction and position, a state vector estimated by converting the error information of the user direction and position estimated by the direction estimating device 100, and the error information of the current user direction and position detected by the direction/position detecting unit 330 into an error covariance matrix, and executing observation updating processing in the Kalman filter framework. In this way, as the correcting processing executed by the correcting unit 350, various types of correcting processing can be applied according to the situation, and it is not especially limited.

When the current user direction and position independently detected by the direction/position detecting unit 330 has been corrected by the correcting unit 350, the notifying unit 360 notifies a result of the correction to the user. The result of the correction notified to the user includes information of whether correction has been made. Further, information related to a decreased error amount, correction amounts of the position and direction, and a direction correcting device, and/or the like may be included in the result of the correction notified to the user. Examples of the notification method include, for example, a method of indicating characters, figures and/or the like on a display unit, a method of notifying the result with sounds, and a method of notifying the result with vibration with a vibrator or the like. It is desirable that these notification content and methods can be appropriately selected by the user.

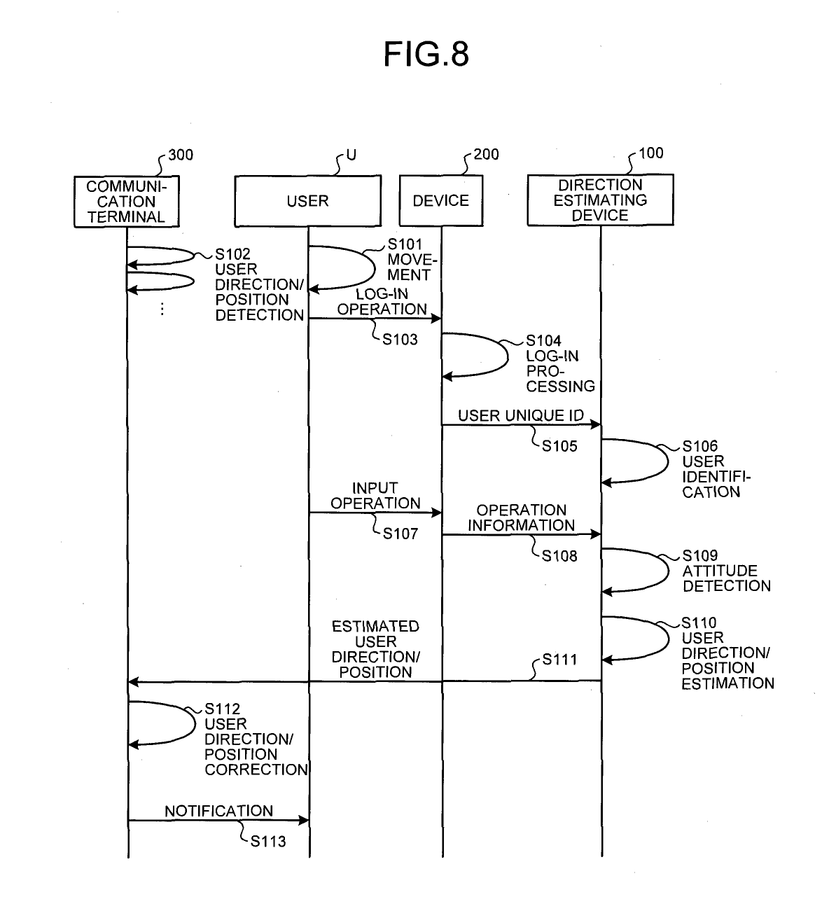

Next, a series of operations in the direction estimating system of the present embodiment will be described with reference to FIG. 8. FIG. 8 is a sequence diagram illustrating an operation of the direction estimating system. The example of FIG. 8 assumes a scene in which a user U moves in an indoor work space toward own seat by foot, and then operates the keyboard (input device 210) of the personal computer (device 200) at the own seat with both hands, so that the user direction and position detected by the communication terminal 300 independently are corrected.

While the user U moves toward the own seat (step S101), the communication terminal 300 possessed by the user U continues to detect the user direction and position by the PDR (step S102). Assume that errors are accumulated in the user direction and position detected by the communication terminal 300.

Following that, when the user sits on the own seat, and performs a log-in operation to the device 200 (step S103), the log-in processing is performed in the device 200 (step S104), and the user unique ID corresponding to the user U is transmitted from the device 200 to the direction estimating device 100 (step S105).

When the user unique ID has been transmitted from the device 200, in the direction estimating device 100, the identifying unit 140 checks the user unique ID with the user information 111 stored in the storage unit 110, thereby to perform processing of identifying who the user U is (step S106). With the user identifying processing, the communication terminal 300 possessed by the user U is identified.

Following that, when the user U performs an input operation using the input device 210 (step S107), the operation information according to the input operation is transmitted from the device 200 to the direction estimating device 100 (step S108). The operation information includes the input device unique ID corresponding to the input device 210 operated by the user U and the device unique ID. Here, assume that the operation information indicates that the user U is operating the input device 210 with both hands.

In the direction estimating device 100, when the operation information has been transmitted from the device 200, the attitude detecting unit 150 determines the attitude of the user U based on the operation information, and detects that the user U is in a particular attitude (here, the user U is operating the input device 210 with both hands) (step S109). Then, when the user U being in the particular attitude has been detected, the estimating unit 160 estimates the current user direction and position of the user U who is operating the input device 210, based on the direction information and the position information associated with the input device unique ID included in the operation information, from among the direction/position information 113 stored in the storage unit 110 (step S110). Then, the communication unit 130 transmits the current user direction and position of the user U estimated in step S110 to the communication terminal 300 identified in the user identifying processing of step S106 (step S11).

In the communication terminal 300, when the estimated current user direction and position of the user has been transmitted from the direction estimating device 100, the correcting unit 350 corrects the current user direction and position independently detected by the direction/position detecting unit 330, based on the user direction and position estimated by the direction estimating device 100 and the error information thereof (step S112). Then, the notifying unit 360 executes processing of notifying a result of the correction in step S112 to the user U (step S113). Accordingly, even in an indoor environment where accurate information of geomagnetic field cannot be obtained, the current user direction and position of the user U can be accurately detected.

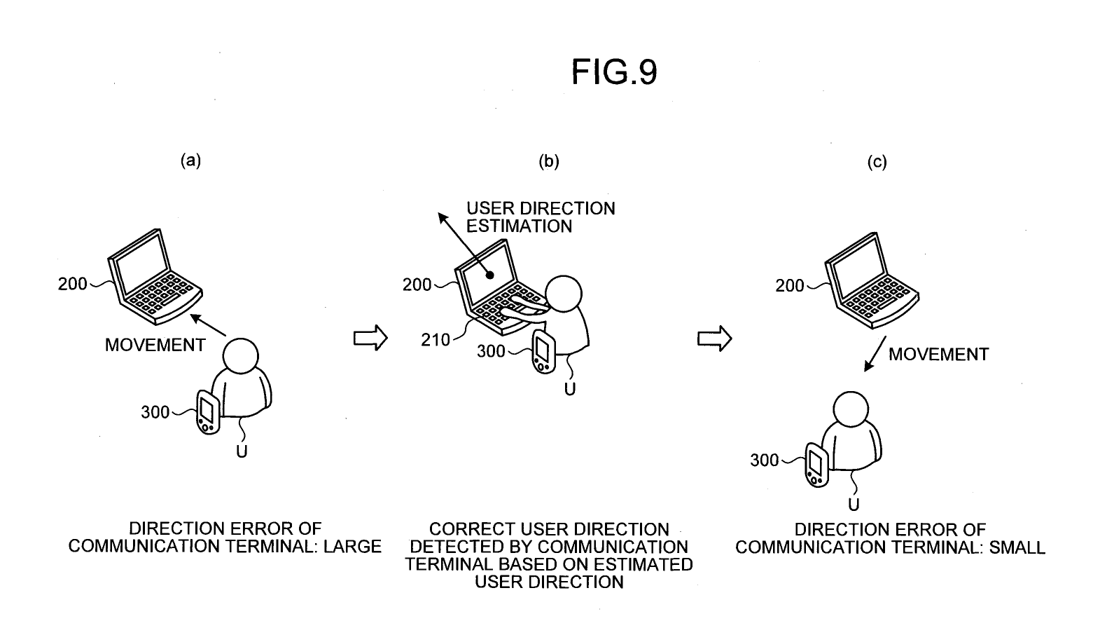

FIG. 9 is a schematic diagram illustrating a state in which the user direction detected by the communication terminal 300 independently is corrected in an operation scene illustrated by the sequence diagram of FIG. 8.

As illustrated in FIG. 9(a), the user U who possesses the communication terminal 300 moves in the indoor work space toward own seat by foot. At this time, the communication terminal 300 independently continues to detect the user direction of the user U by the PDR. However, the estimation accuracy is deteriorated due to accumulation of direction estimation errors.

Following that, as illustrated in FIG. 9(b), when the user U sits on the own seat, and operates the keyboard (input device 210) of the personal computer (device 200) at the own seat, the direction estimating device 100 estimates the current user direction corresponding to the attitude of the user U. Then, the user direction estimated by the direction estimating device 100 is transmitted to the communication terminal 300 possessed by the user U. The communication terminal 300 corrects the user direction detected by the communication terminal 300 independently, based on the user direction estimated by the direction estimating device 100. As a result, the direction estimation accuracy by the communication terminal 300 is improved.

Following that, as illustrated in FIG. 9(c), the user U leaves the own seat and moves by foot. At this time, while the communication terminal 300 independently continues to detect the user direction of the user U by the PDR, the estimation accuracy of the user direction has been improved, because the correction has been made based on the user direction estimated by the direction estimating device 100 when the user U operates the keyboard (input device 210) of the personal computer (device 200) at the own seat with both hands.

As described in detail by taking a specific example, in the direction estimating system of the present embodiment, the direction estimating device 100 estimates the current user direction when the user operates the input device 210 of the device 200 with a particular attitude. Then, the direction estimating device 100 corrects the user information independently detected by the communication terminal 300, based on the estimated user direction. Therefore, according to the direction estimating system of the present embodiment, the direction detection accuracy in an indoor environment can be improved.

(Modification)

While the direction estimating device 100 described above is an example implemented as a server device, the direction estimating device 100 of the present embodiment can be realized as one function of the device 200, as described above. In this case, functional configuration elements illustrated in FIG. 2 are realized in the device 200. However, as the device information 112 and the direction/position information 113 stored in the storage unit 110, only information related to the own device may be stored. Further, the communication unit 130 may just have a function to perform communication with the communication terminal 300.

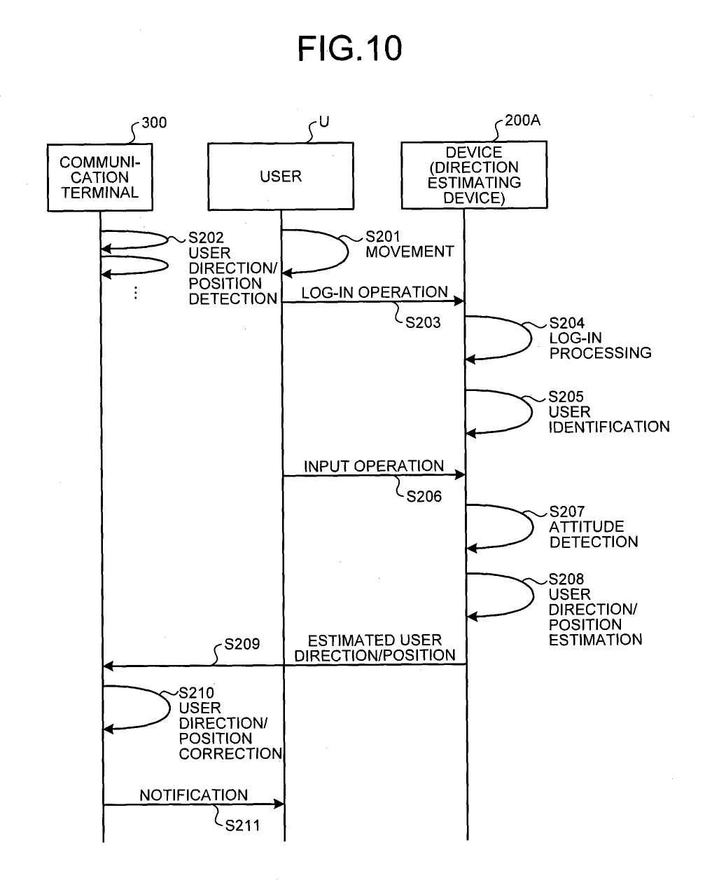

FIG. 10 is a sequence diagram illustrating an operation of a direction estimating system of when the direction estimating device 100 is realized as one function of the device 200. The example of FIG. 10 assumes a scene similar to the example of FIG. 8. Hereinafter, the device 200 having the function of the direction estimating device 100 is written as device 200A.

While the user U moves toward the own seat (step S201), the communication terminal 300 possessed by the user U continues to detect the user direction and position by the PDR (step S202). Assume that errors are accumulated in the user direction and position detected by the communication terminal 300.

Following that, when the user U sits on the own seat, and performs the log-in operation to the device 200A (step S203), the device 200A performs the log-in processing (step S204), and acquires the user unique ID corresponding to the user U. Then, the identifying unit 140 checks the user unique ID with the user information 111 stored in the storage unit 110, thereby to perform processing of identifying who the user U is (step S205). With the user identifying processing, the communication terminal 300 possessed by the user U is identified.

Following that, when the user U operates the input device 210 with both hands to perform an input (step S206), the attitude detecting unit 150 determines the attitude of the user U based on the operation information according to the input operation, and detects that the user U is in a particular attitude (here, the user U is operating the input device 210 with both hands) (step S207). Then, when the attitude detecting unit 150 has detected that the user U is in the particular attitude, the estimating unit 160 estimates the current user direction and position of the user U who is operating the input device 210, based on the direction information and the position information associated with the input device unique ID included in the operation information, from among the direction/position information 113 stored in the storage unit 110 (step S208). Then, the communication unit 130 transmits the current user direction and position of the user U estimated in step S208 to the communication terminal 300 identified in the user identifying processing of step S205 (step S209).

In the communication terminal 300, when the estimated current user direction and position of the user U has been transmitted from the direction estimating device 100, the correcting unit 350 corrects the current user direction and position independently detected by the direction/position detecting unit 330, based on the user direction and position estimated by the direction estimating device 100, and the error information thereof (step S210). Then, the notifying unit 360 executes processing of notifying a result of the correction in step S210 to the user U (step S211). Accordingly, even in an indoor environment where accurate information of geomagnetic field cannot be obtained, the current user direction and position of the user U can be accurately detected.

As described above, when the direction estimating device 100 is realized as one function of the device 200, the device 200A estimates the current user direction when the user operates the input device 210 of the device 200A. Then, the device 200A corrects the user direction independently detected by the communication terminal 300, based on the estimated user direction. Therefore, even if the direction estimating device 100 is realized as one function of the device 200, the direction detection accuracy in an indoor environment can be improved, similarly to the case where the direction estimating device 100 is realized as a server device.

### Second Embodiment

Next, a direction estimating device 100A of a second embodiment will be described. The direction estimating device 100A of the second embodiment performs notification of prompting a user to take a particular attitude, and detects that the user is in the particular attitude and estimates a user direction and a position when there is a response to the notification. Note that other configurations and operations are similar to those described in the first embodiment. Therefore, hereinafter, the similar configurations to the first embodiment are denoted with the same reference signs and overlapping description is omitted, and only characteristic portions of the second embodiment will be described.

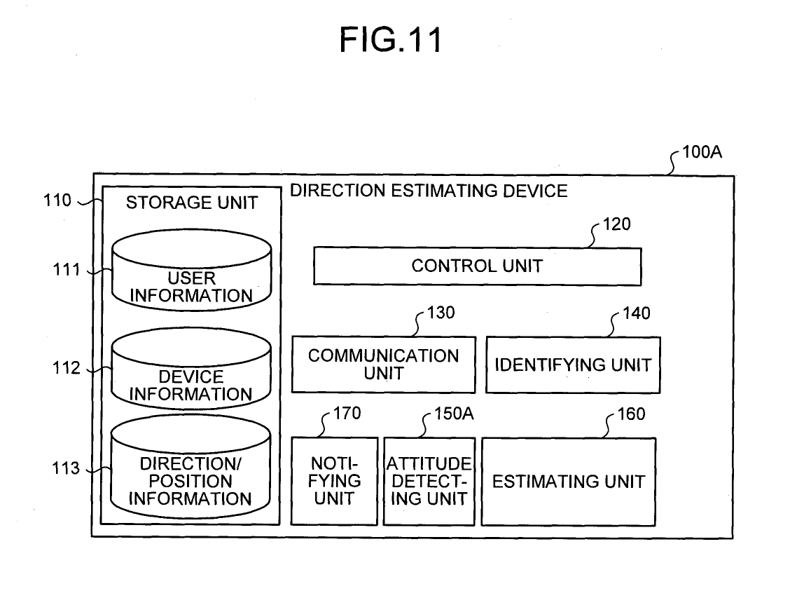

FIG. 11 is a block diagram illustrating a functional configuration example of the direction estimating device 100A of the second embodiment. The direction estimating device 100A of the second embodiment includes a notifying unit 170, in addition to the configuration of the direction estimating device 100 of the first embodiment. Further, the direction estimating device 100A of the second embodiment includes an attitude detecting unit 150A, in place of the attitude detecting unit 150 of the direction estimating device 100 of the first embodiment.

The notifying unit 170 performs notification of prompting the user to take a particular attitude. To be specific, the notifying unit 170 performs a predetermined notification operation, such as displaying a message that prompts the user to take the particular attitude on a display device of a device 200, or outputting audio guidance that prompts the user to take the particular attitude from a speaker of the device 200. The notification by the notifying unit 170 is performed, for example, when detection accuracy of a user direction or position by a communication terminal 300 possessed by the user is low, or when the user direction or position is uncertain in the communication terminal 300 possessed by the user (when the user starts to use the communication terminal 300).

To be specific, for example, when the user performs a log-in operation to the device 200, and a user unique ID is transmitted to the direction estimating device 100A, a control unit 120 of the direction estimating device 100A identifies the communication terminal 300 possessed by the user from the user unique ID. Then, the control unit 120 of the direction estimating device 100A requests the identified communication terminal 300 to transmit the user direction and position, verifies the user direction and position transmitted from the communication terminal 300 in response to the request, and determines whether the detection accuracy of the user direction or position is low, or whether the user direction or position is in an uncertain state. Then, the control unit 120 of the direction estimating device 100A starts the notifying unit 170, and executes the notification operation by the notifying unit 170 when the detection accuracy of the user direction or position by the communication terminal 300 is low, or when the user direction or position is uncertain in the communication terminal 300.

When there is a response from the user to the notification operation by the notifying unit 170, the attitude detecting unit 150A detects that the user is in a particular attitude. With regard to the response from the user to the notification operation, a predetermined method may just be determined in advance, such as a predetermined button operation or key operation specified to operate when the user takes the particular attitude.

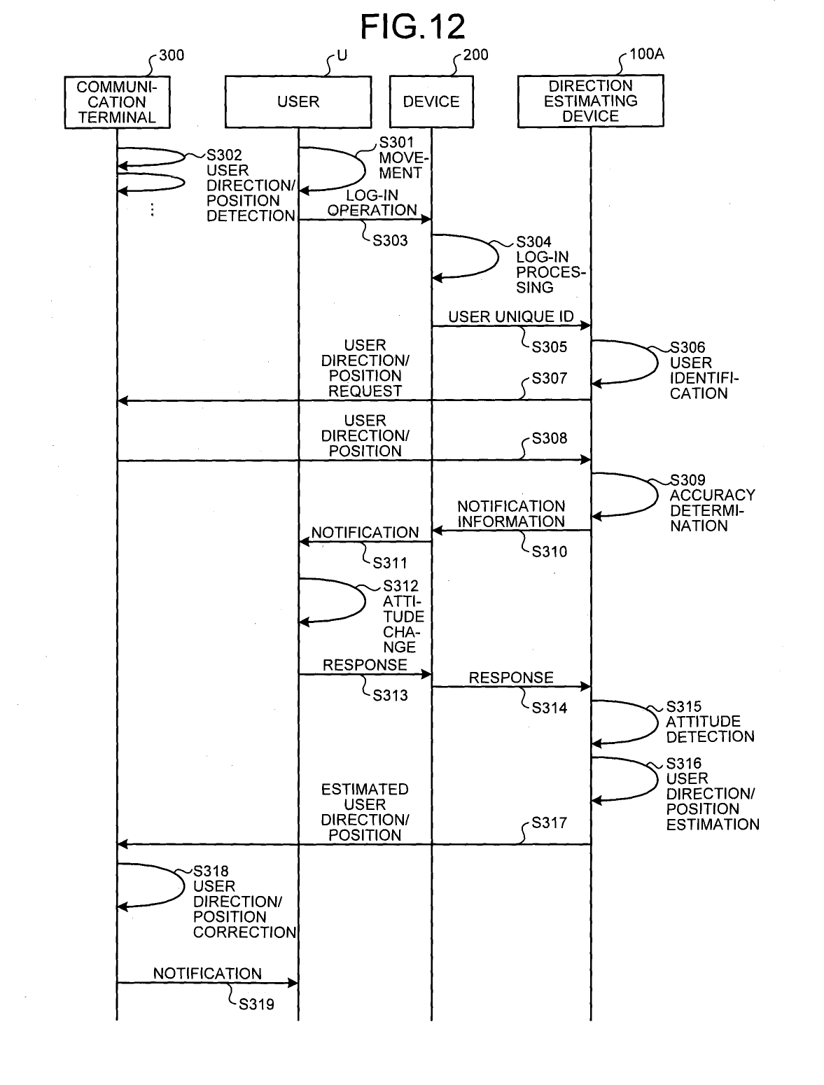

A series of operations in a direction estimating system of the present embodiment will be described with reference to FIG. 12. FIG. 12 is a sequence diagram illustrating an operation of the direction estimating system. The example of FIG. 12 assumes a scene in which a user U moves in an indoor work space toward own seat by foot, performs a log-in operation to the personal computer (device 200) at the own seat, and then takes the particular attitude according to the notification performed using the device 200, so that the user direction and position detected by the communication terminal 300 independently are corrected.

While the user U moves toward the own seat (step S301), the communication terminal 300 possessed by the user U continues to detect the user direction and position by the PDR (step S302). Assume that errors are accumulated in the user direction and position detected by the communication terminal 300.

Following that, when the user U sits on the own seat, and performs a log-in operation to the device 200 (step S303), log-in processing is performed in the device 200 (step S304), and the user unique ID corresponding to the user U is transmitted from the device 200 to the direction estimating device 100A (step S305).

In the direction estimating device 100A, when the user unique ID has been transmitted from the device 200, an identifying unit 140 checks the user unique ID with user information 111 stored in a storage unit 110, thereby to perform processing of identifying who the user U is (step S306). With the user identifying processing, the communication terminal 300 possessed by the user U is identified.

Next, the control unit 120 of the direction estimating device 100A requests the communication terminal 300 identified in the user recognition processing of step S306 to transmit the user direction and position detected by the communication terminal 300 independently (step S307). In response to the request, the communication terminal 300 transmits the user direction and position detected by the communication terminal 300 independently, to the direction estimating device 100A (step S308).

Next, the control unit 120 of the direction estimating device 100A determines the detection accuracy of the user direction and position in the communication terminal 300 based on the user direction and position transmitted from the communication terminal 300 (step S309). Here, assume that the detection accuracy of the user direction and position in the communication terminal 300 is low. Therefore, the notifying unit 170 of the direction estimating device 100A transmits the notification information to the device 200 for performing notification of prompting the user U to take a particular attitude (for example, an attitude directly facing a display device of the device 200 (step S310). Based on the notification information from the notifying unit 170 of the direction estimating device 100A, the device 200 displays a message that prompts the user U to take the particular attitude in the display device, or outputs audio guidance that prompts the user to take the particular attitude from the speaker, whereby the notification to the user U is performed (step S311). Note that the notification operation to the user U may be performed not only when the detection accuracy of the user direction or position in the communication terminal 300 is low, but also when the user direction or position is in an uncertain state in the communication terminal 300.

Next, when the user U changes the attitude according to the notification in step S311 (step S312), and performs a response such as a predetermined button operation or key operation (step S313), the response of the user U is notified from the device 200 to the direction estimating device 100A (step S314). This notification includes a device unique ID of the device 200 to which the user U has performed the log-in operation, and an input device unique ID of an input device 210.

In the direction estimating device 100A, the attitude detecting unit 150A detects that the user is in the particular attitude (the attitude directly facing the display device of the device 200, for example), in response to the response of the user U (step S315). Then, when the user has been determined to be in the particular attitude, an estimating unit 160 estimates a current user direction and position of the user U based on direction information and position information associated with the input device unique ID included in the notification of the response of the user, from among direction/position information 113 stored in the storage unit 110 (step S316). Then, a communication unit 130 transmits the current user direction and position of the user U estimated in step S316 to the communication terminal 300 identified in the user identifying processing of step S306 (step S317).

In the communication terminal 300, when the estimated current user direction and position of the user U has been transmitted from the direction estimating device 100A, a correcting unit 350 corrects the current user direction and position detected by a direction/position detecting unit 330 independently, based on the user direction and position estimated by the direction estimating device 100A, and error information thereof (step S318). Then, a notifying unit 360 executes processing of notifying a result of the correction in step S318 to the user U (step S319). Accordingly, even in an indoor environment where accurate information of geomagnetic field cannot be obtained, the current user direction and position of the user U can be accurately detected.

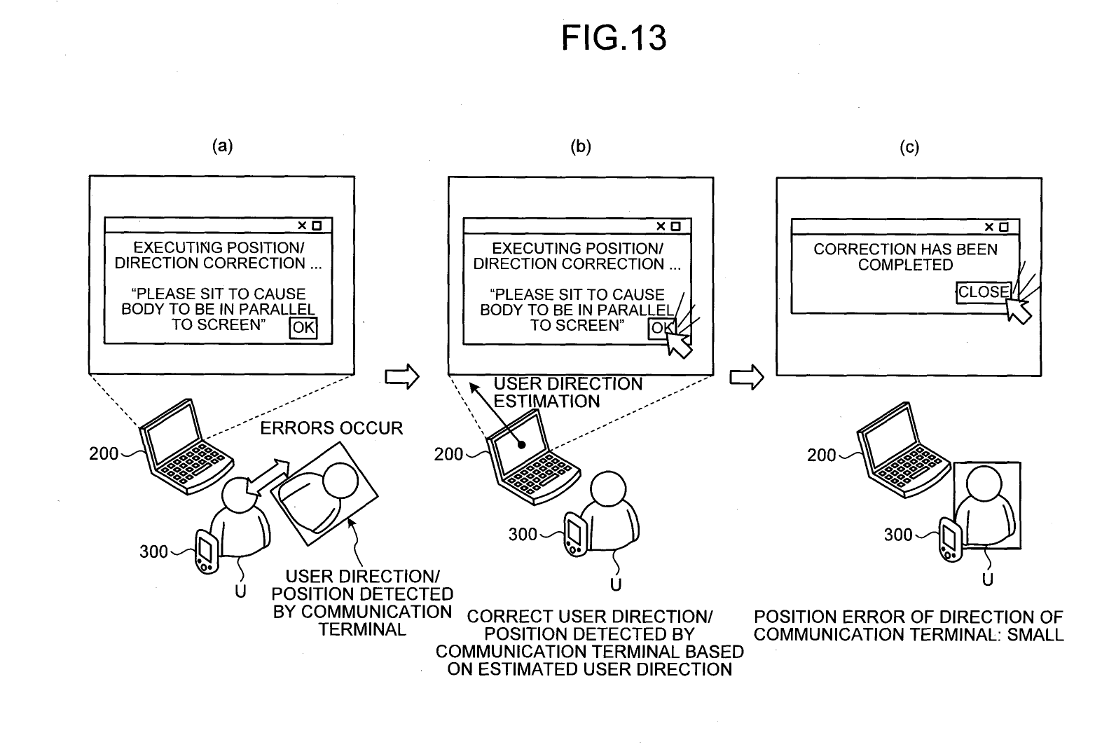

FIG. 13 is a schematic diagram illustrating a state in which the user direction detected by the communication terminal 300 independently is corrected in an operation scene illustrated by the sequence diagram of FIG. 12. The communication terminal 300 independently continues to detect the user direction of the user U by the PDR while the user U moves toward the own seat by foot. However, the estimation accuracy of the user direction is deteriorated due to accumulation of direction estimation errors.

As illustrated in FIG. 13(a), when the user U who possesses the communication terminal 300 sits on the own seat, and performs the log-in operation to the personal computer (device 200) at the own seat, the message that prompts the user to take an attitude directly facing the display device is displayed in the display device of the device 200. At this time, the user direction and position detected by the communication terminal 300 independently are deviated from actual user direction and position.

Next, as illustrated in FIG. 13(b), when the user U takes the attitude directly facing the display device according to the message displayed in the display device of the device 200, and operates an “OK” button, the direction estimating device 100A estimates the current user direction and position according to the attitude of the user U. Then, the direction estimating device 100A transmits the estimated user direction and position to the communication terminal 300 possessed by the user U. The communication terminal 300 corrects the user direction and position detected by the communication terminal 300 independently, based on the user direction and position estimated by the direction estimating device 100A. As a result, the direction estimation accuracy and the position detection accuracy by the communication terminal 300 are improved.

Following that, as illustrated in FIG. 13(c), a massage of completion of the correction is displayed on the display device of the device 200. Then, the user U presses a “close” button, so that the notification operation using the device 200 is terminated. Afterward, correction of the user direction and position detected by the communication terminal 300 independently has been made based on the user direction and position estimated by the direction estimating device 100A. Therefore, the estimation accuracy of the user direction and position is improved.

As described above, in the direction estimating system of the present embodiment, when the user takes the particular attitude according to the notification operation that is performed by the direction estimating device 100A using the device 200, the direction estimating device 100A estimates the current user direction. Then, the user direction detected by the communication terminal 300 independently is corrected based on the user direction estimated by the direction estimating device 100A. Therefore, according to the direction estimating system of the present embodiment, the direction detection accuracy in an indoor environment can be improved, similarly to the first embodiment.

Note that the direction estimating device 100A of the present embodiment may be implemented in combination with the direction estimating device 100 of the first embodiment. That is, the attitude detecting unit 150A of the direction estimating device 100A may detect that the user is in the particular attitude based on the operation information of when the user operates the input device 210, in addition to the detection that the user is in the particular attitude when there is the response from the user to the notification operation.

Further, the direction estimating device 100A of the present embodiment may be realized not only as a server device but also as one function of the device 200 similarly to the modification of the first embodiment.

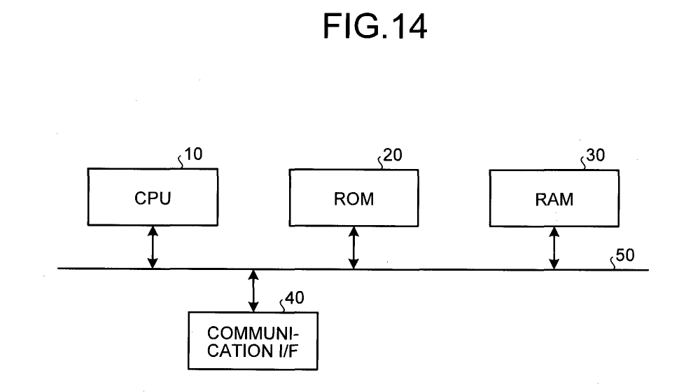

Here, a hardware configuration example of the direction estimating device 100 (100A) of the embodiments will be described. FIG. 14 is a block diagram illustrating a hardware configuration example of the direction estimating device 100 (100A) of the above-described embodiments.

As illustrated in FIG. 14, the direction estimating device 100 (100A) includes a control device such as a CPU 10, a storage device such as a ROM 20 and a RAM 30, a communication I/F 40 connected to a network and performing communication, an external device (not illustrated) such as an HDD or a CD drive device, and a bus 50 that connects the units, and has a hardware configuration using a normal computer. Functions of the direction estimating device 100 (100A) can be realized by execution of a predetermined program in the above hardware configuration.

The program executed in the direction estimating device 100 (100A) of the embodiments are recorded in a recording medium readable by the computer, such as a CD-ROM, a flexible disk (FD), a CD-R, or a DVD, in an installable format file or an executable format file and provided. Further, the program executed in the direction estimating device 100 (100A) of the embodiments may be incorporated in the ROM 20 or the like and provided.

Further, the program executed in the direction estimating device 100 (100A) of the embodiments may be stored on a computer connected to a network such as the Internet, and provided by being downloaded through the network. Further, the program executed in the direction estimating device 100 (100A) of the embodiments may be provided or distributed through the network such as the Internet.

The program executed in the direction estimating device 100 (100A) of the embodiments has a module configuration including the above-described units (the control unit 120, the communication unit 130, the identifying unit 140, the attitude detecting unit 150 (the attitude detecting unit 150A), and the estimating unit 160 (the notifying unit 170)). As actual hardware, the CPU 10 (processor) reads a detection program from the storage medium and executes the program, whereby the respective units are loaded to the RAM 30 (main storage) and are generated on the RAM 30.

In the above-described embodiments, a personal computer used by the user is assumed as the device 200, and a keyboard is assumed as the input device 210. However, the present invention can be broadly applied when a device (input device) with which the user is assumed to take a particular attitude when naturally performing some operation (in a state where a load to the user is low and the operability is high) is used.

To be specific, for example, office devices such as multifunctional peripherals in an office environment, automated teller machines (ATMs) installed in banks, or automatic ticket gate devices installed in stations are assumed that the user takes a particular attitude when naturally operating such devices. Therefore, the present invention can be implemented using these devices as the devices 200 of the embodiments. Further, the device 200 may be a mobile body, in addition to one fixed to a predetermined position. For example, a shopping cart used in a shop causes the user to take a particular attitude when the user pushes and moves the cart with both hands. Further, an automobile causes the user to take a particular attitude when the user holds a handle and performs acceleration/braking operations. Therefore, the present invention can be implemented using these cart and automobile as the devices 200 of the above-described embodiments.

According to an embodiment, an effect of improving direction detection accuracy in an indoor environment is exhibited.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### REFERENCE SIGNS LIST

100, 100A Direction estimating device
110 Storage unit
113 Direction/position information
120 Control unit
130 Communication unit
140 Identifying unit
150, 150A Attitude detecting unit
160 Estimating unit
170 Notifying unit
200 Device
210 Input device
300 Communication terminal
320 Control unit
330 Direction/position detecting unit
340 Communication unit
350 Correcting unit
360 Notifying unit

### CITATION LIST

### Patent Document

### Patent Document 1: JP 2012-088253 A

### Patent Document 2: JP 2004-264028 A

### Patent Document 3: WO 2010/001970 A

### Patent Document 4: JP 5061264 B

1. A direction estimating device that estimates a user direction indicating a direction of a body of a user, comprising:
a storage unit that stores direction information indicating a direction determined in advance as the user direction of when the user operates an input device with a particular attitude;
a detecting unit that detects that the user is in the particular attitude; and
an estimating unit that estimates the user direction based on the direction information when the user has been detected to be in the particular attitude.

2. The direction estimating device according to claim 1, wherein
the input device is an input device operated by the user with both hands, and
the detecting unit detects that the user is operating the input device with both hands as the particular attitude.

3. The direction estimating device according to claim 1, further comprising:
a notifying unit that performs notification that prompts the user to take the particular attitude, wherein
the detecting unit detects that the user is in the particular attitude when there is a response from the user to the notification.

4. The direction estimating device according to claim 1, wherein
the storage unit further stores position information indicating a position determined in advance as a user position of when the user operates the input device with the particular attitude, and
the estimating unit further estimates the user position based on the position information when the user has been detected to be in the particular attitude.

5. The direction estimating device according to claim 1, further comprising:
an identifying unit that identifies the user; and
a transmitting unit that transmits the user direction estimated by the estimating unit to a communication terminal possessed by the user who has been identified by the identifying unit.

6. The direction estimating device according to claim 5, wherein the communication terminal includes a function to receive the user direction transmitted by the transmitting unit, a function to detect the user direction using an inertial navigation method, and a function to correct the detected user direction based on the received user direction.

7. A direction estimating system to which a direction estimating device that estimates a user direction indicating a direction of a body of a user, and a communication terminal possessed by the user are communicatively connected,
the direction estimating device including:
a storage unit that stores direction information indicating a direction determined in advance as the user direction of when the user operates an input device with a particular attitude;
a first detecting unit that detects that the user is in the particular attitude;
an estimating unit that estimates the user direction based on the direction information when the user has been detected to be in the particular attitude;
an identifying unit that identifies the user; and
a transmitting unit that transmits the user direction estimated by the estimating unit to the communication terminal possessed by the user identified by the identifying unit, and
the communication terminal including:
a receiving unit that receives the user direction transmitted by the transmitting unit;
a second detecting unit that detects the user direction using an inertial navigation method; and
a correcting unit that corrects the detected user direction based on the received user direction.

8. A method of estimating a direction executed in a direction estimating device that estimates a user direction indicating a direction of a body of a user, wherein
the direction estimating device includes a storage unit that stores direction information indicating a direction determined in advance as the user direction of when the user operates an input device with a particular attitude, and
the method comprises:
detecting that, by the direction estimating device, the user is in the particular attitude; and
estimating, by the direction estimating device, the user direction based on the direction information when the user has been detected to be in the particular attitude.
